(19) United States
(12) Patent Application Publication
(10) Pub. No.: US 2024/0286198 A1
(43) Pub. Date: Aug. 29, 2024

(54) Method for the Additive Manufacturing of a Component

(71) Applicant: Siemens Aktiengesellschaft, München (DE)

(72) Inventors: Raven Thomas Reisch, München (DE); Tobias Hauser, Bubesheim (DE); Tobias Kamps, München (DE)

(73) Assignee: Siemens Aktiengesellschaft, München (DE)

(21) Appl. No.: 18/570,775

(22) PCT Filed: May 17, 2022
(86) PCT No.: PCT/EP2022/063225

§ 371 Date: Dec. 15, 2023

(30) Foreign Application Priority Data
Jun. 18, 2021 (EP) 21180372.1

(51) Int. Cl. B22F 10/85; B22F 12/90; B23K 9/04; B33Y 10/00; B33Y 30/00; B33Y 50/02

(52) U.S. Cl. CPC B22F 10/85; B22F 12/90; B23K 9/042; B33Y 10/00; B33Y 30/00; B33Y 50/02

(57) ABSTRACT

Various embodiments of the teachings herein include a method for the additive manufacture of a component. The method may include: training a representation with datasets from a previously executed manufacturing process with a known process result; calculating output data from input data; and creating an adaptive anomaly detection model trained on a parameter-set-specific basis with available training data. The method may include transferring the machine code and the detection models to a control system; starting the manufacturing process; monitoring the process with sensors; evaluating sensor signals of the manufacturing process using the generalized anomaly detection model; training a specialized anomaly detection model in parallel from an adaptive anomaly detection model using process data of the running manufacturing process; and detecting anomalies in the manufacture of the component using the specialized anomaly detection model during the manufacturing process.

### CROSS-REFERENCE TO RELATED APPLICATIONS

This application is a U.S. National Stage Application of International Application No. PCT/EP2022/063225 filed May 17, 2022, which designates the United States of America, and claims priority to EP application Ser. No. 21/180,372.1 filed Jun. 18, 2021, the contents of which are hereby incorporated by reference in their entirety.

### TECHNICAL FIELD

The present disclosure relates to additive manufacturing. Various embodiments of the teachings herein include methods and/or systems for manufacturing a component using additive manufacturing.

### BACKGROUND

Wire arc additive manufacturing (WAAM) is one example that enables the manufacture of large-volume, metal components. A further typical process for this is the laser metal deposition process (LMD). In this case the lack of repeatability of the process represents a challenge for quality assurance. To ensure that the component is of sufficiently high quality the process must be monitored. In-situ monitoring systems in this case enable on-the-spot analysis of what is happening during the process.

If defects are then identified in the process, the knowledge obtained hitherto about the defects is not used to make process adjustments. The reason for this is that it is not known which defect is present and how it should be tackled. If an anomaly is detected the process must therefore be aborted for the moment and the component is rejected.

### SUMMARY

The teachings of the present disclosure include systems and methods for the additive manufacture of a component which in comparison to the prior art has improved process control and reduces the rejection rate during production. For example, some embodiments include a method comprising: creating a machine code; creating a generalized anomaly detection model and creating an adaptive anomaly detection model; transferring the machine code and the detection models to a control system; starting the manufacturing process; monitoring the process with sensors; evaluating sensor signals of the manufacturing process with the help of the generalized anomaly detection model; parallel training of a specialized anomaly detection model from an adaptive anomaly detection model by means of process data of the running manufacturing process; and detection of anomalies in the manufacture of the component with the help of the specialized anomaly detection model during the manufacturing process.

As another example, some embodiments include a method for the additive manufacture of a component (2) comprising: creating a machine code; creating a generalized anomaly detection model-to which end a representation from training data is trained, wherein the training data originates from datasets of sensor data from a previously executed manufacturing process with a known process result; training the representation with the training data, wherein to this end output data is calculated from input data; and creating an adaptive anomaly detection model which is trained on a parameter-set-specific basis with available training data; transferring the machine code and the detection models to a control system; starting the manufacturing process; monitoring the process with sensors; evaluating sensor signals of the manufacturing process with the help of the generalized anomaly detection model; parallel training of a specialized anomaly detection model from an adaptive anomaly detection model by means of process data of the running manufacturing process; and detection of anomalies in the manufacture of the component with the help of the specialized anomaly detection model during the manufacturing process.

In some embodiments, an adaptive anomaly detection model trained in respect of a process parameter set is stored as a specialized anomaly detection model and when the process parameter set is reused the specialized anomaly detection model is used.

In some embodiments, the specialized anomaly detection model is used at the start of a second manufacturing process with a second process parameter set and is trained by the adaptive anomaly detection model.

In some embodiments, the method further includes: parallel development of a digital twin (10) of the resulting component (2) during the process from the sensor data comprising position data of detected anomalies (8); prediction via the position (12) of a printhead (14) at a particular time by means of the machine code; analysis of a working area around this position in respect of anomalies present by means of the digital twin; and adjustment of the process parameters on reaching the working area for the elimination of the anomaly.

In some embodiments, the anomalies determined by the anomaly detection models are introduced into the digital twin.

In some embodiments, a timestamp is assigned to each position (12) approached by the printhead (14).

In some embodiments, the digital twin (10) includes a point cloud (16) and an anomaly value is determined for each point by means of one of the anomaly detection models for which a process state is stored.

In some embodiments, data of a working area (18) from adjacent points (17), (17′) is included to determine the anomaly value.

In some embodiments, the working area (18) has the spatial extent of a liquid phase (20) prevailing at the observation time point.

In some embodiments, the point cloud is represented in a spatially structured data structure in the form of an octree.

In some embodiments, the working area (18) is represented by a double ellipsoid (22).

In some embodiments, the adjustment of the process parameters for the elimination of the anomaly (8) includes a higher heat input.

In some embodiments, the adjustment of the process parameters for the elimination of the anomaly (8) includes a lower printhead speed.

In some embodiments, the additive manufacturing method is wire arc additive manufacturing.

As another example, some embodiments include an additive manufacturing device for the performance of one or more of the methods described herein comprising a robot arm, a control system and a printhead as well as sensors for the detection of process parameters.

### BRIEF DESCRIPTION OF THE DRAWINGS

Further embodiments and further features are explained in greater detail on the basis of the following figures, in which:

FIG. 1 shows a schematic representation of a system for wire arc additive manufacturing incorporating teachings of the present disclosure;

FIG. 2 shows the operating sequence over time when training anomaly detection models during a process incorporating teachings of the present disclosure;

FIG. 3 shows the effect of the training phase of the anomaly detection model on the prediction quality incorporating teachings of the present disclosure;

FIG. 4 shows an illustration of a point cloud of a digital twin of a resulting component incorporating teachings of the present disclosure; and

FIG. 5 shows a working area in the form of a double ellipsoid for determining anomalies incorporating teachings of the present disclosure.

### DETAILED DESCRIPTION

The terms used here are defined as follows:

### Machine Code

A machine code is a series of instructions that are created in accordance with the rules of a higher programming language and that can be executed directly (without further translation) by the processor of a device, for example a control system with electronic data processing. One example that can be mentioned of a machine code for industrial control systems such as Sinumerik for instance is G-Code (DIN 66025). Another example would be specialized robot programming languages such as KRL (Kuka Robot Language) or RAPID.

### Model

Models serve firstly for mapping a section of reality in order to solve a task with the help of information processing. Models such as these are called domain models. Included herein for example are models for software to be created, in particular for the code thereof (in the form of program operating plan diagrams, for example) and data models for the description of the structures of data to be processed from the operational/logic perspective or from the technical data retention perspective (in the form of neural networks, for example).

### Anomaly

An anomaly refers to the component to be manufactured and usually represents a defect or the precursor to a defect, for example an oxidation cluster in the resulting component. Such anomalies in the component should wherever possible be detected during the manufacturing process by means of sensors and should likewise be compensated for or eliminated during the manufacturing process.

### Generalized Anomaly Detection Model

A model, for example a neural network, is suitable for representing training data through learning, so that output data can be calculated from input data. Training data is, for example, datasets of sensor data from an already completed manufacturing process that has delivered a known, for example good, process result in the form of a component.

A generalized anomaly detection model is a model trained on available training data; the aim of the training is to generate the model that has a high degree of accuracy when calculating the output data on the basis of the input data for all parameter sets. The generalized anomaly detection model can be used with different parameter sets, but it has a lower accuracy of calculation compared to a specialized model. The specialized model is a model trained on a parameter-set-specific dataset that is based on an adaptive model. A new parameter set is conditionally trained within a few steps and/or within a short period of time. It can be used for specific parameter sets and, due to its specialization, has a higher accuracy when calculating anomalies on the basis of a special parameter set compared to the generalized anomaly detection model.

### Process Data

Process data is all the data that accrues during the process. This includes the sensor signals and at least in part the process parameter set.

### Process Parameter Set

The process parameter set includes all technical variables used during the process, for example position and speed of the printhead at a certain time, but in particular machine settings such as energy input (for example in the form of current and voltage), distance of a welding torch from the component, gas flow or arc length correction.

### Adaptive Anomaly Detection Model

An adaptive anomaly detection model is a trained model based on a neural network that is conditioned to available training data (i.e. trained on a parameter-set-specific basis); the aim of the training (for example via a meta-learning approach, for example such as Model Agnostic Meta-Learning or Reptile) is to generate a model that is quickly adaptable, especially during a timespan of 0.5 s to 3 s and with little training data, for a new set of process parameters. Adaptable means that the model can be brought to a specialized state with as little further parameter-set-specific training data as possible and/or few steps and/or in as short a time as possible. This means that the specialized anomaly detection model is created on the basis of the adaptive model. The adaptive anomaly detection model is in itself not directly suitable for use in anomaly detection. It is therefore not well suited for this purpose since it is designed to be adaptable as quickly as possible and using a small amount of training data and not to achieve the best possible detection results.

### Control System

A control system is a computing unit that is able to execute models and to process the data. Examples of control systems are NCs (numerical controllers such Sinumerik), edge devices as (Industrial Edge or Sinumerik Edge (a computer that connects two networks and can evaluate data)), an IPC (Industrial PC without a connection to the second network) or a PLC (Programmable Logic Controller, such as Simatic S7 for example).

### Sensor and Sensor Signal

A sensor, also referred to as a detector, (measured variable or measurement) pickup or (measurement) sensor, is a technical component that can detect certain physical or chemical properties (physical, for example amount of heat, temperature, humidity, pressure, sound field variables, brightness, acceleration or chemical, for example pH value, ionic strength, electrochemical potential) and/or the material property of its surroundings qualitatively or quantitatively as a measured variable. These variables are detected by means of physical, chemical or biological effects and are converted into a signal suitable for further processing, in particular an electrical signal, the sensor signal. An electrical signal is a special form of physical signal. It is an electrical variable such as current strength, voltage or resistance if it is variable in some way and can thus record and transport information. Possible values of the signal include, for example, equivalence, peak value, frequency, phase shift angle or duty cycle. The values that the sensor signal delivers are referred to as sensor data. Mathematical evaluations, in other words further processing of physical sensor data, are also referred to as sensor data as such.

### Printhead

The printhead is the component of an additive manufacturing device that is responsible for the material deposition. In WAAM, this is the element on which the end of the wire to be welded is guided; in the LMD process, this is the element on which the laser beam emerges to fuse the powder. During the process, the printhead is at a specific position over a defined feature, for example the tip of an electrode or a wire exit opening. This position of the printhead in turn correlates spatially equidistantly with a working point in or on the surface of the resulting component. A distinction is therefore made between the position of the printhead and the working point on the component, since in different additive manufacturing processes these do not coincide spatially, but are always positively controlled in relation to one another.

### Position Data

Position data is a dataset that, starting from a coordinate system defined prior to the start of a process, defines in respect thereto a location in the process environment.

### Digital Twin

A digital twin is a digital representation of a tangible or intangible object or process from the real world in the digital world. Digital twins enable a comprehensive exchange of data. They are more than pure data and consist of models of the represented object or process and can additionally contain simulations, algorithms and services that describe, influence or offer services about the properties or behavior of the represented object or process.

The teachings of the present disclosure described may offer the following advantages in contrast to the prior art. In order to cope with the high number of process parameters, conventional algorithms are used, such for example averaging in combination with limit value formation. Especially in the case of high-frequency data with complex patterns in the data, information is lost, since it is not used in the analysis. In order nevertheless to be able to analyze complex signal properties, the described adaptive anomaly detection model comes into play. For this a sufficient number of training datasets is collected with a parameter set in the process. With the help of this data, the anomaly detection model specialized on the determined parameters is generated from the adaptive anomaly detection model. If this exists, it can be used for the sensor signals in this special parameter set for anomaly detection. Adjusting the process parameters means that the specialized model becomes obsolete and the adjustment by means of the adaptive anomaly detection model must take place again. The early and reliable detection of anomalies in the resulting component offers considerable advantages for the manufacturing process, since either a reject can be identified at an earlier stage and manufacturing resources and manufacturing times can be saved or, even more advantageously, detected anomalies can be eliminated in situ.

In this connection it is expedient if an adaptive anomaly detection model trained in respect of a process parameter set is stored as a specialized anomaly detection model and when the process parameter set is reused the specialized anomaly detection model is used. This shortens the training time described above by means of the adaptive anomaly detection model, in which otherwise only the generalized anomaly detection model is available. Furthermore, the adaptive anomaly detection model can be used when starting a second manufacturing process with a second process parameter set and with the help of the new training data can be adapted thereto in order to create a further specialized model.

In some embodiments, the manufacturing method also comprises:
parallel development of a digital twin 10 of the resulting component 2 during the process from the sensor data comprising position data of detected anomalies 8;
prediction as to the position 12 of a printhead 14 at a particular time by means of the machine code;
analysis of a working area around this position in respect of anomalies present by means of the digital twin; and/or
adjustment of the process parameters on reaching the working area for the elimination of the anomaly.

Thanks to the anomaly detection as described, anomalies can be detected at an early stage and can be responded to by adjusting the process parameters on the spot or in the area surrounding the anomaly in the resulting component, wherein the process greatly depends on the current surrounding area (in particular a melt zone in the resulting component). If for example in layer three an oxidation occurs as an anomaly, this likewise results in abnormal process behavior in the following layer. The same applies for adjacent welding beads. Thanks to the anomaly detection as described the current data points of anomalies are first provided. The context that is present at the respective point in time is taken up in the described form of embodiment of the method and is introduced into the simulation and implementation of compensation measures.

Thus an oxidation or a deviation in shape also has an impact on the following layers and the data collected here. The impact of defects across multiple layers is now taken sufficiently into account with the described method, so that defects across multiple layers can be correlated with one another. Thus information that already exists is used to obtain better results in data analysis in the context of in-situ monitoring, and is not lost. Temporal and spatial context, to which great importance is attached in the additive manufacturing process, is profitably used by the described solution during data evaluation, and defect elimination measures can be introduced in situ.

Suitable additive manufacturing methods, in which the described method can be advantageously configured, are in particular wire arc additive manufacturing (WAAD)) and laser metal deposition (LMD). To this end the results of the anomaly detection by means of the anomaly detection models may be introduced into the digital twin.

In some embodiments, the digital twin is configured in the form of a point cloud and for an evaluation to be stored for each point in the cloud for the process state. Examples of evaluation criteria are the nature of the anomaly (for example oxidation or pores). An anomaly is thus a precursor to a defect, and can also be referred to as a potential defect. An anomaly value may be determined for each point, for the calculation of which information, in other words process data and sensor data from adjacent points within a working area, is in turn included.

The spatial extent of a liquid phase prevailing at the time of observation may be used as the working area. The shape of a double ellipsoid, which is easy to understand mathematically in the evaluation, may be userful for determining the working area and its virtual transfer to the digital twin. In some embodiments, the working area is continuously changed with the shape and size of the liquid phase, in other words a local melt pool. The shape and size of the liquid phase can be detected for example by means of a welding camera or derived from the component temperature and the current energy input. A special form of the double ellipsoid is the ellipsoid that is symmetrical with respect to half its longitudinal axis. The sphere is a special form of the ellipsoid.

In some embodiments, the adjustment of the process parameters may be implemented for the elimination of the anomaly on the spot or in the area surrounding the anomaly, in order for example to burn off oxidation by means of locally increased heat input and/or to slow the speed of movement of the printhead in order to fuse and thus eliminate a porous structure.

The decision as to whether process parameters are adjusted, at which point in time and in which location, is in this case based on a prediction of where the printhead will have moved to within a defined timespan in accordance with the machine code. The area surrounding the thus calculated position is then searched through for anomalies (for example interrogation of the octree by means of double ellipsoids). If anomalies are present in the area surrounding this position, countermeasures are initiated (for example increasing the heat input, the speed of movement).

Suitable additive manufacturing methods, in which the described method can be advantageously configured, are in particular wire arc additive manufacturing (WAAD) and laser metal deposition (LMD).

Some examples include an additive manufacturing device for the performance of one or more of the methods described herein comprising a robot arm, a control system and a printhead as well as sensors for detecting process parameters.

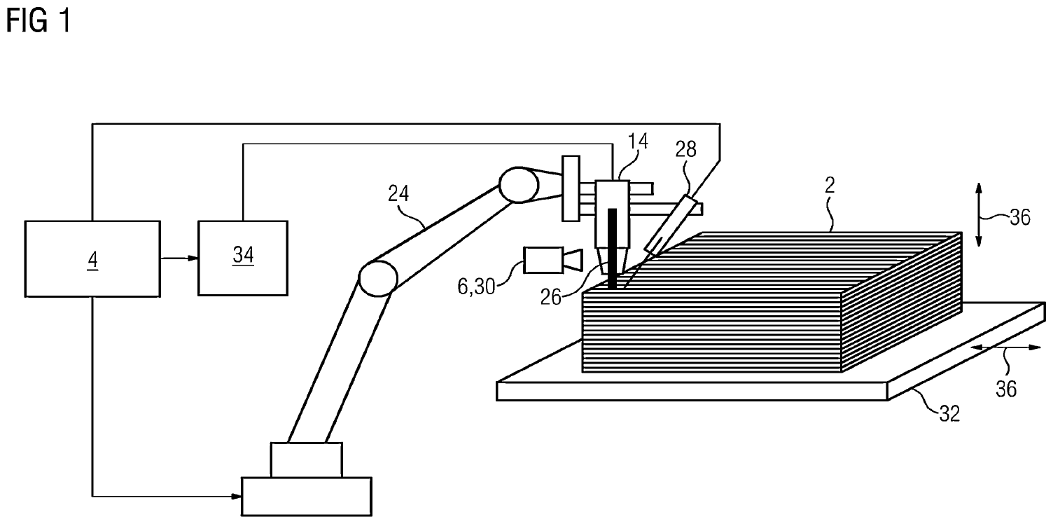

FIG. 1 shows a schematic representation of an additive manufacturing process for the manufacture of a component 2 incorporating teachings of the present disclosure. This additive manufacturing process is by way of example configured as wire arc additive manufacturing (WAAM). Analogously, what is described below could also be applied to another additive manufacturing process, such as laser metal deposition for example. In this case a printhead 14 with an electrode 26 is directed to a particular position of a component 2 via a robot arm 24. Furthermore, a welding wire 28 is provided, which is fused by the electrode 26 at a corresponding position 12 of the printhead 14. Furthermore, a control system 4 is provided, as well as an energy supply 34, via which both the electrode 26 and a feed of the welding wire and of the robot arm are supplied with energy. The whole process is controlled via the control system 4, which is further touched upon below. In particular, the process is monitored by a plurality of sensors. Purely by way of example, a sensor 6 is represented in the graphic FIG. 1 in the form of a welding camera 30.

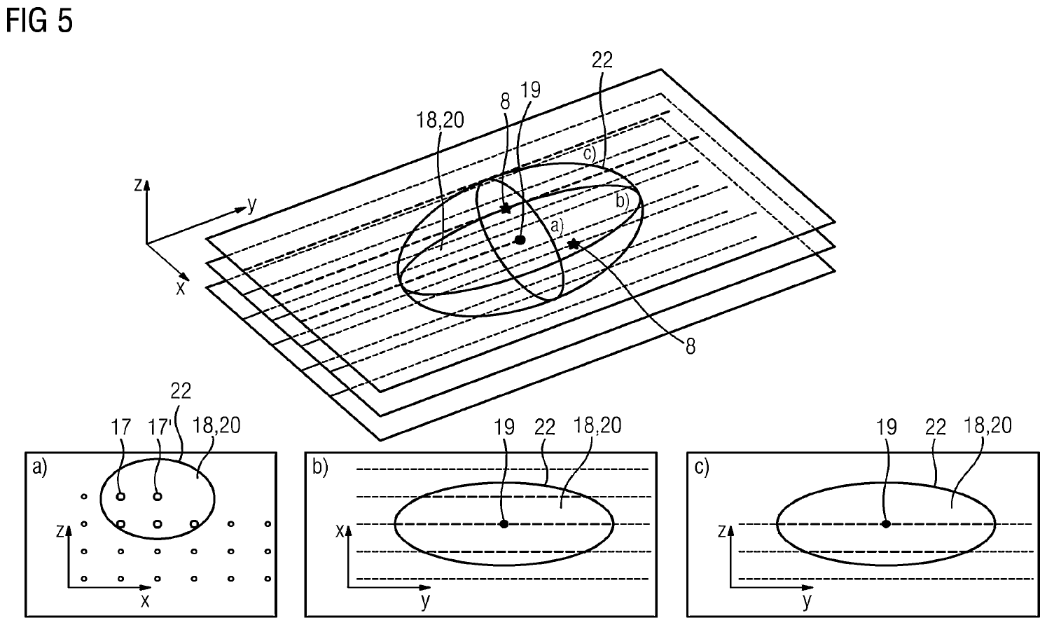

Using the welding camera 30 it is possible for example for values such as the geometry of a liquid phase 20, which is touched upon further in FIG. 5, to be determined. Further sensor data for example includes the voltage and the current flow in the process, the temperature of the liquid phase 20, the feed of the printhead 14 and the feed speed of the welding wire.

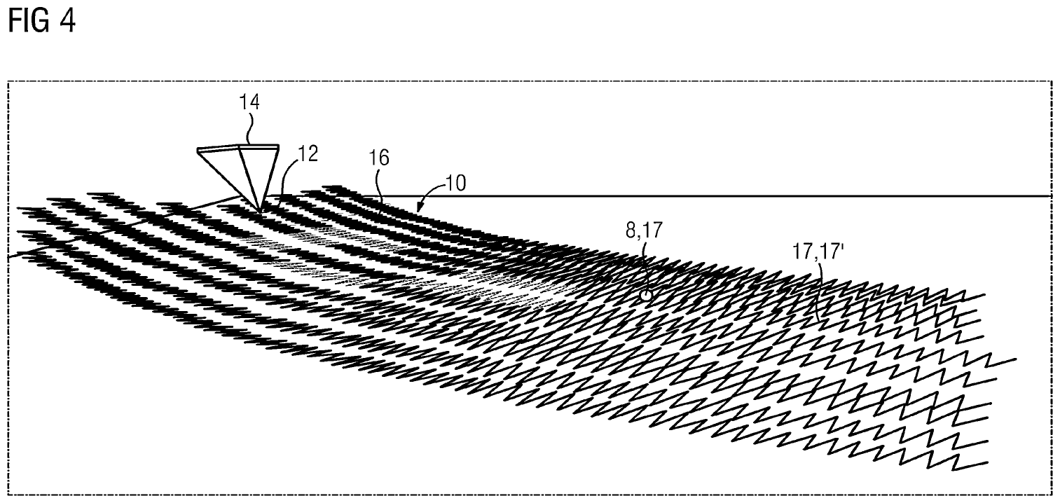

At each position 12 of the printhead 14, which unambiguously assignably correlates to a position in the component 2, both the position data in the form of a point in a coordinate system as well as a timestamp are preferably recorded and are passed to the control system 4. In the control system 4 or in a computer connected thereto a digital twin 10, which is illustrated schematically in FIG. 4, is simultaneously created during the printing of the component 2. In this case the digital twin 10 includes a point cloud 16, in which the printhead 14 or the position 12 thereof is likewise schematically represented by a triangular tip. In this case an anomaly value is calculated for each point 17 from the sensor data of the point cloud 10 that is determined and transferred to the control system.

To evaluate the anomaly value, which will be touched upon later, a working area 18 is first defined on the component 2 (FIG. 5), which is represented in the digital twin by an ellipsoid, which essentially comprises a liquid phase 20 in the real component 2, in which the material of the welding wire has just fused on a surface of the component 2. When considering liquid phases, a double ellipsoid has in particular proven to be expedient. The working area becomes particularly relevant if a correlation of detected anomalies is to take place, the anomaly density is to be determined, or compensation strategies are to be implemented.

In this liquid phase 20, anomalies 8, which may be precursors to defects, may arise when applying the welding wire 28. Defects may for example be oxidation, which arises if impurities are present on the welding wire 28, or are introduced in the process. Air pockets in the form of pores may also be anomalies and may become defects. During the evaluation of anomalies not only is the respective point 17 under consideration evaluated, but adjacent points 17′ that are present in the working area 18, transferred to the digital twin 10 in the ellipsoid 22, are also used. This is represented in the sectional views in FIGS. 5, 5a, 5b and 5c. An anomaly value is calculated for each point 17 or 17′, and this is then taken into consideration if the printhead 14 comes into the vicinity of the thus determined anomaly 8 a further time. The printhead 14 can in this case spatially affect the anomaly 8 from multiple sides, so that by changing the process parameters in the vicinity of the anomaly 8 this can be compensated for, so that a defect possibly resulting from the anomaly can be eliminated even before it arises. The advantage compared to conventional additive manufacturing processes is that thanks to the described procedure the development of defects is counteracted and thus the rejection of components 2 is significantly reduced.

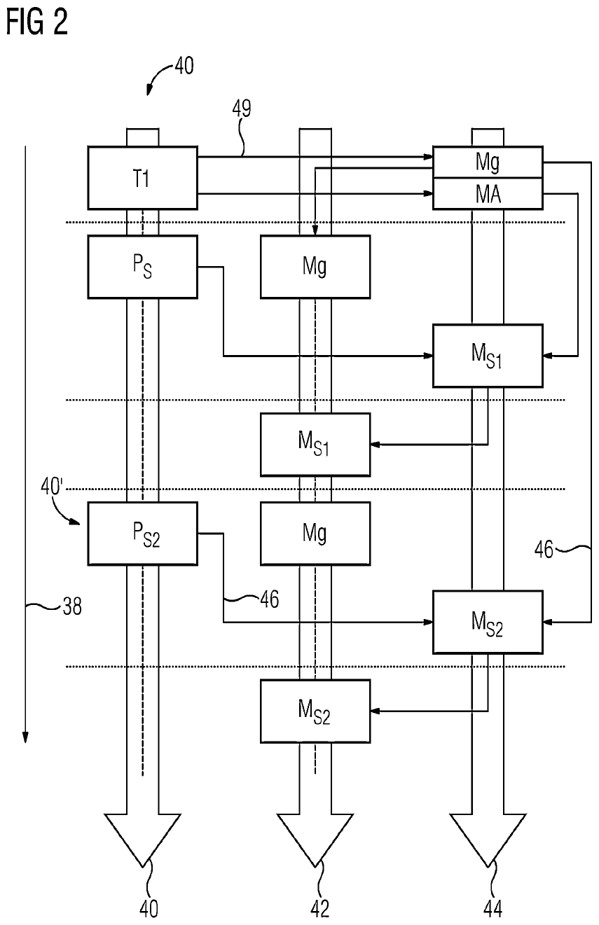

An important basis for eliminating the defects is the early identification thereof by a suitable evaluation of the process parameters and process data during the manufacturing process. This is done by means of anomaly detection models. The operational sequence of the process using anomaly detection models may be illustrated by FIG. 2. In this, three tracks of the process along a time axis 38 are illustrated by the three arrows 40, 42, 44. In this case the operational sequence of the actual process 40 is represented on the left, the associated status of the anomaly detection 42 running in parallel thereto in the center, and the operational sequence over time of the training phases 44 of anomaly detection models during the process sequence on the far right. The thin arrows between the individual boxes in the diagram represent the data flow 46.

The process sequence is in this case as follows. First, process data in the form of training data T1 is for example generated from earlier processes. This is supplied to a generalized anomaly detection model Mg, by means of which the process is monitored at the start (Ps). The generalized anomaly detection model Mg is employed in a first phase of the process to identify anomalies. The generalized anomaly detection model Mg is, as already set out in the introduction, a model trained on available training data, wherein the basic aim of the training is to generate the model, which has a high degree of accuracy when calculating the output data on the basis of the input data for all parameter sets. The generalized anomaly detection model Mg can be employed with various parameter sets, but it has a lower degree of accuracy of calculations compared to a specialized model MS1.

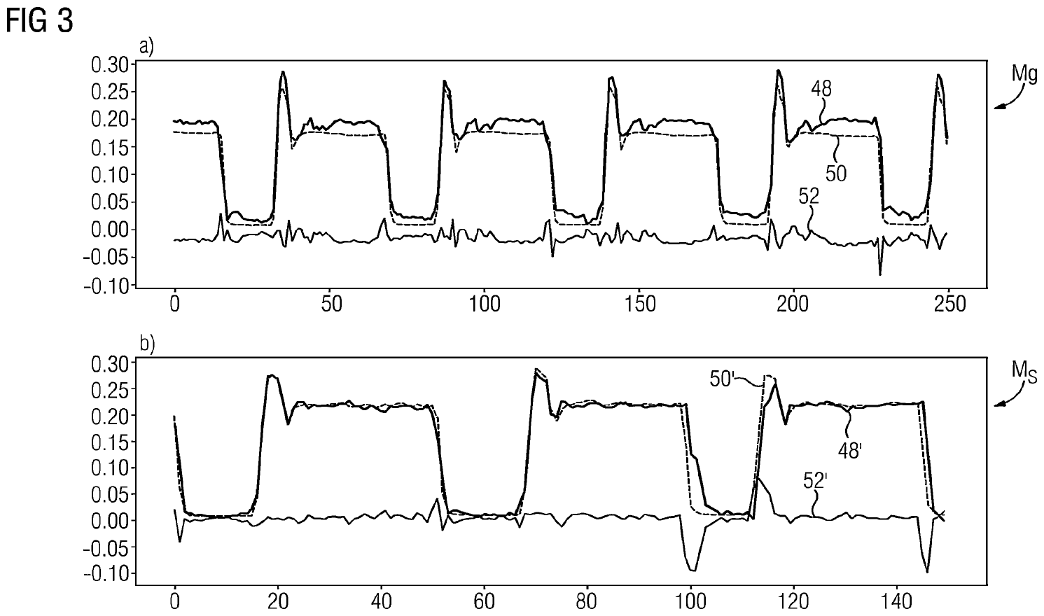

To illustrate how the generalized anomaly detection model Mg works, two different graphs are plotted in FIG. 3 along a time axis. The normalized voltage or the difference between the real and predicted normalized voltage is plotted on the y-axis (which is why the axis is without units). In this case the prediction of process data and thus further of anomalies by means of the generalized anomaly detection model 48 is represented in FIG. 3a, which however largely corresponds in detail somewhat roughly to the real, measured data 50. The graph 52 shows the error interval between the curves 48 and 50.

While the process is continued and possible anomalies in the resulting component 2 are predicted by means of the generalized anomaly detection model Mg and thus are detected, at the same time the specialized anomaly detection model Ms1 is developed by means of an adaptive anomaly detection model Ma (FIG. 2) through multiple iteration cycles. The time for the development of this specialized anomaly detection model Ms1 depending on process control, between 0.5 s and 5 s, generally between 1 s and 3 s. If the development of the specialized anomaly detection model Ms1 from the adaptive anomaly detection model Ma is concluded, the generalized anomaly detection model Mg is replaced and the further anomaly detection is continued by means of the anomaly detection model Ms1 specialized for this process. This represents a second phase, the main phase of the process. In FIG. 3b it can be seen that the modeled data 48′ matches the measured data 50 significantly better than is the case with the generalized anomaly detection model in accordance with FIG. 3a.

The time of the second phase, in which the process 40 is operated with the generalized anomaly detection model Mg, is therefore relatively short and the largest part of the process is continued with the specialized anomaly detection model Ms1 created iteratively by means of the adaptive anomaly detection model Ma. This specialized anomaly detection model Ms1 can be stored in a database and used again when manufacturing a component with the same process parameter set, without in this case having to perform the process start with the generalized anomaly detection model Mg.

However, a further process Ps2, characterized on the process arrow by 40, using a new parameter set first restarts using the generalized anomaly detection model, wherein in parallel in accordance with arrow 44 a further specialized anomaly detection model Ms2 is trained by means of the adaptive anomaly detection model Ma and thanks to the data flow 46 data from a first training interval is made available to the adaptive anomaly detection model Ma.

The method described in respect of FIGS. 1-3 is explained below in greater detail with other aspects. For the integration of the temporal context use is made of (neural network) models, that on the basis of past values (for example of the last 0.5 seconds) evaluate the current (data) point 17 in respect of an anomaly value. The timespan, which is used as a temporal context, in this case changes dynamically, depending on how high the current welding speed (in other words the feed speed of the printhead 14) is and how long the weld pool is. The length of the weld pool can for example be detected via the welding camera 30 in conjunction with a computer vision algorithm evaluation, such as for example Canny Edge Detection. As a result, it is always ensured that all process values that are relevant to the current liquid weld pool are included in the calculation of the anomaly value.

For the analysis of the data, use can be made either of regression models (prediction), such as for example Seasonal ARIMA models or neural networks on the basis of Conv1D or RNN/LSTM elements, or models for the reconstruction of the data with the help of autoencoders. For the prediction of the data use can also be made of batch-processing CNN structures in addition to the RNN/LSTMs with a temporal memory.

Temporal structures in the data, such as for example frequency changes or irregular patterns, are thus included in the process evaluation. For training, process data with constant process parameters must be used in order to achieve a high degree of accuracy.

Each location (position 12 of the printhead 14) approached by the printhead 14 is preferably given a timestamp, which provides information about when it was approached.

The spatial context contains information about relevant cross-layer information, for example from the previous layer or from adjacent welding tracks. To this end, as described a digital map of the digital twin 10 of the component 2 is therefore simultaneously created during the manufacturing process, in that all relevant information is stored. This digital twin 10 includes a point cloud, in which for each point an evaluation of the process status (for example normal/abnormal, anomaly value, type of the anomaly, . . . ) as well as a timestamp are stored. The point cloud can in this case be stored on a spatially structured basis, so that a more efficient interrogation by spatial structures such as for example a double ellipsoid or a sphere becomes possible. A data structure such as this is for example the octree, the r-tree or the kd-tree, which via their tree-like structure permit a rapid search for points in space.

For the integration of the spatial context into the calculation of the anomaly value of a current working point 19 (which is spatially equidistantly connected to the printhead) the space around the current working point 19 is included in the data analysis. To this end, a three-dimensional working area 18 is defined around the working point 19, via which the spatial relevance of the data points 17, 17′ is established. This working area 18 in this case includes the area occupied by the weld pool, in other words the phase 20 that is liquid during the additive manufacturing. As a simplification, a sphere or more generally an ellipsoid or even more generally a double ellipsoid can be used here in accordance with FIG. 3.

The axial lengths of the ellipsoids can adjust adaptively to the geometry of the weld pool. A comparison can take place here dynamically either on the basis of sensor data such as for example from the welding camera 30 (extracting the geometry of the weld pool), with the help of process parameters such as for example the process speed (a higher welding speed results in a thinner, longer ellipsoid) or on the basis of a previously performed thermal simulation (temperature profile, size and shape of the weld pool). Furthermore, the timestamps of the points 17 contained or simulation results can be included in order to draw a conclusion about the existing cooling behavior and thus the size of the weld pool.

On the basis of the defined working area 18, points 17 are selected that are created in the process history and augmented with meta-information such as for example an anomaly probability value, a value for defect criticality or a defect type. For this, data structures such as for example an octree are used, which permit spatial indexing and thus an optimized spatial search for the points in question. Each point in this case contains information about local process anomalies or defects, so that a spatially selected point cloud containing relevant information results in the area immediately surrounding the current working point 19. The information contained is now used on the one hand to improve the identification of anomalies and on the other hand to make adjustments to the process.

The result of the anomaly evaluation by the models (including the temporal context) is an anomaly value that provides a statement about the probability of the anomaly and thus of the defect. At this point the spatial context is now included in two different ways: if an anomaly has been identified, it can be semantically connected to other anomalies via the spatial context information. As a result, the spatial extent of the anomaly and thus of the potential defect becomes visible. In this case the above-mentioned double ellipsoid maps the relevant space in which defects are correlated with one another. If for example an oxidation arises in the first layer, then a problem with bonding is created in the following layer. Both these defects are mutually dependent, so that the spatial extent of the abnormal area in the component can now be better estimated.

If for example there are multiple potential anomalies in a highly stressed area of a component, each with a low anomaly value, each of which would not in itself result in rejection, but which together result in a failure of the component, the anomaly density can additionally be determined, in order in this way to estimate whether a critical accumulation of anomalies has been reached in an area of the component. The context space for the anomaly density does not necessarily only occupy the space of the weld pool (liquid phase 20), but can also be larger as a function of component 2 (for example in the area of thin webs, which could otherwise become undesired predetermined breaking points due to anomalies). Thus an anomaly density in the component 2 can be determined in situ. If this exceeds a limit value, the process can be stopped at an early stage and costs due to rejects can be reduced.

With the help of the temporal and spatial context a classification of the defects can additionally be carried out. To this end a neural network is used for the classification and assumes preprocessed process values as an input variable (in predictive models distance between predicted and real value or in models for the reconstruction of the reconstruction errors). In a last layer a sigmoid function is used in order to assign a probability value to each defect. If for example it is known that the previous layer has already cooled down significantly, since the difference in the time stamps is large, an adhesion defect can be concluded with a higher probability. Furthermore, in the event of oxidation in an adjacent layer, for example, there is a higher probability of a defect due to dirt being trapped.

### LIST OF REFERENCE CHARACTERS

2 Component
4 Control system
6 Sensors
8 Anomaly
10 Digital twin
12 Position printhead
14 Printhead
16 Point cloud
17, 17′ Points
18 Working area
19 Working point
20 Liquid phase
22 Ellipsoid
24 Robot arm
26 Electrode
28 Welding wire
30 Welding camera
32 Work table
34 Energy supply
36 Approach path work table
Pₛ Process start
38 Process time axis
40 Process
42 Anomaly detection
44 Separation
46 Data flow
T1 Training data
Mg Generalized anomaly detection model (ADM)
MA Adaptive ADM
MS1 Specialized ADM
48 Modeled data
50 Measured data
52 Error interval

What is claimed is:

1. A method for the additive manufacture of a component, the method comprising
creating a machine code;
creating a representation of a generalized anomaly detection model;
training the representation with training data originating from datasets of sensor data from a previously executed manufacturing process with a known process result;
calculating output data from input data;
and
creating an adaptive anomaly detection model
trained on a parameter-set-specific basis with available training data;
transferring the machine code and the detection models to a control system;
starting the manufacturing process;
monitoring the process with sensors;
evaluating sensor signals of the manufacturing process using the generalized anomaly detection model;
training a specialized anomaly detection model in parallel from an adaptive anomaly detection model using process data of the running manufacturing process; and
detecting anomalies in the manufacture of the component using the specialized anomaly detection model during the manufacturing process.

2. The method as claimed in claim 1, further comprising:
storing an adaptive anomaly detection model trained based on a process parameter set as a specialized anomaly detection model; and
when the process parameter set is reused, using the specialized anomaly detection model.

3. The method as claimed in claim 1, further comprising using the specialized anomaly detection model at a start of a second manufacturing process with a second process parameter set; and
training the specialized anomaly detection model with the adaptive anomaly detection model.

4. The method as claimed in claim 1, further comprising:
developing a digital twin of the resulting component in parallel during the process from the sensor data comprising position data of detected anomalies;
predicting via a position of a printhead at a particular time using the machine code;
analyzing a working area around the position based on anomalies present in the digital twin; and
adjusting the process parameters on reaching the working area for the elimination of the anomaly.

5. The method as claimed in claim 4, further comprising introducing the anomalies determined by the anomaly detection models into the digital twin.

6. The method as claimed in claim 4, further comprising assigning a timestamp to each position approached by the printhead.

7. The method as claimed in claim 4, wherein digital twin includes a point cloud and an anomaly value is determined for each point by means of one of the anomaly detection models for which a process state is stored.

8. The method as claimed in claim 7, further comprising including data of a working area from adjacent points to determine the anomaly value.

9. The method as claimed in claim 8, wherein the working area has a spatial extent matching a liquid phase prevailing at the observation time point.

10. The method as claimed in claim 1, wherein the point cloud is represented in a spatially structured data structure in the form of an octree.

11. The method as claimed in claim 7, where the working area is represented by a double ellipsoid.

12. The method as claimed in claim 1, wherein adjustment of the process parameters for the elimination of the anomaly includes a higher heat input.

13. The method as claimed in claim 1, wherein adjustment of the process parameters for the elimination of the anomaly includes a lower printhead speed.

14. The method as claimed in claim 1, the additive manufacturing method comprises wire arc additive manufacturing.

15. An additive manufacturing device comprising:
a robot arm;
a control system;
a printhead;
sensors to detect process parameters;
wherein the control system is configured to:
create a machine code;
create representation of a generalized anomaly detection model;
train the representation with training data originating from datasets of sensor data from a previously executed manufacturing process with a known process result;
calculate output data input data; and
create an adaptive anomaly detection model trained on a parameter-set-specific basis with available training data;
transfer the machine code and the detection models to a control system;
start the manufacturing process;
monitor the process with sensors;
evaluate sensor signals of the manufacturing process using the generalized anomaly detection model;
train a specialized anomaly detection model in parallel from an adaptive anomaly detection model using process data of the running manufacturing process; and
detect anomalies in the manufacture of the component using the specialized anomaly detection model during the manufacturing process.
